(19) United States
(12) Patent Application Publication
(10) Pub. No.: US 2018/0252160 A1
(43) Pub. Date: Sep. 6, 2018

(54) TURBOCHARGER WITH INSULATION DEVICE

(71) Applicant: BorgWarner Inc., Auburn Hills, MI (US)

(72) Inventors: PATRIC HOECKER, LANDAU (DE); WALDEMAR HENKE, DARMSTAT (DE)

(21) Appl. No.: 15/752,613

(22) PCT Filed: Aug. 16, 2016
(86) PCT No.: PCT/US2016/047129

§ 371 Date: Feb. 14, 2018

(30) Foreign Application Priority Data
Aug. 28, 2015 (DE) 10 2015 216 507.8

(51) Int. Cl. F02C 6/12; F01D 17/16; F01D 25/12; F01D 25/16

(52) U.S. Cl. CPC F02C 6/12; F01D 17/16; F05D 2220/40; F01D 25/16; F01D 25/12

(57) ABSTRACT

The present invention relates to a turbocharger comprising a bearing housing, a turbine housing which is connected to the bearing housing, and a cartridge. The cartridge comprises a blade bearing ring and a disk, wherein a plurality of blades is arranged between blade bearing ring and disk. An insulation device is arranged between the disk and the turbine housing.

### FIELD OF THE INVENTION

The present invention relates to a turbocharger with variable turbine geometry and an insulation device.

### BACKGROUND OF THE INVENTION

Turbochargers are used increasingly often in engines of the new generation. The goals thereby are to enable similar or higher engine power and driving performance at similarly low consumption and at lower emissions. A further measure to achieve these goals is to reduce weight, from motor vehicles in general and specifically from individual components. For this purpose, light-weight construction materials are used, like aluminum and carbon fiber reinforced plastics. There are also attempts to save weight in the area of the turbocharger. However, care must be taken as the components of a turbocharger are subjected to very high loads, particularly temperature loading. For example, temperatures above 950° C. may occur in the area of the volute of a turbine of an exhaust gas turbocharger. In addition, the durability and the lifecycle have great relevance for a component like the turbocharger. The object of the present invention is accordingly to provide a turbocharger which enables the use of lighter-weight materials and simultaneously has a high durability and long lifecycle.

### BRIEF SUMMARY OF THE INVENTION

The present invention relates to a turbocharger with variable turbine geometry (VTG) according to claim 1.

The turbocharger according to the invention has a bearing housing, a turbine housing which is connected to the bearing housing, and a cartridge. The cartridge comprises a blade bearing ring and a disk, wherein a plurality of blades is arranged between the blade bearing ring and the disk. An insulation device is arranged between the disk and the turbine housing. During operation, hot exhaust gases are guided by the turbine housing between the blade bearing ring and the disk of the cartridge of the variable turbine geometry. An insulation device between the disk of the VTG cartridge and the turbine housing has the advantage that the components are thermally decoupled. This means that the high temperatures, which the disk may reach during operation, are not directly transferred to the turbine housing. This is particularly advantageous in case the turbine housing is manufactured from materials which have weight advantages, like aluminum, however are not suited for persistent high temperature loading. This means that the material of the turbine housing is subjected to lower stress. Due to the lower stress and temperature loading, a higher durability and thus a higher lifecycle may be achieved for the turbocharger.

In the embodiments, the insulation device may be arranged between a first radial surface of the disk, which faces in the direction of the turbine housing, and a second radial surface of the turbine housing.

In embodiments, which may be combinable with all previously described embodiments, the insulation device may be arranged between an outer circumferential surface of a continuation of the turbine housing, which extends in the direction of the bearing house, and an inner circumferential surface of the disk, which defines a central hole in the disk. Alternatively, the insulation device may be arranged between an inner circumferential surface of a continuation of the turbine housing, which extends in the direction of bearing housing, and an outer circumferential surface of the disk.

In embodiments, which are combinable with all previously described embodiments, the insulation device may have a disk-shaped component. The disk-shaped component may be designed as planar. The insulation device may have a sleeve-like component. In embodiments, the disk-shaped component and the sleeve-like component may be designed as an integral component, wherein the sleeve-like component extends from the disk-shaped component in the direction of the bearing housing. The insulation device may thereby have a rotationally-symmetrical component which has an L-shaped cross section. One part of the L-shaped cross section thereby runs in the axial direction and the other part runs in the radial direction. This embodiment of the insulation device has the advantage that a direct contact or adjoining surfaces may be prevented between the disk of the VTG cartridge and the turbine housing. Thus, a good thermal insulation and a low heat transfer are enabled from the disk to the turbine housing.

In embodiments, which are combinable with all previously described embodiments, the disk may open in the radially outward direction or in the radially inward direction into an interior space of the turbine housing. This area is thereby not directly surrounded by the turbine housing. This has the advantage that the contact areas or areas with adjoining surfaces or directly surrounding surfaces are kept to a minimum between the disk of the VTG cartridge and the turbine housing.

In embodiments, which are combinable with all previously described embodiments, the turbine housing may have a cooling device. The cooling device may comprise cooling ducts which are arranged in the turbine housing. In particular, the ducts may be designed such that a coolant may circulate therein. The coolant may, for example, comprise water. The turbine housing may comprise aluminum. By using aluminum for the turbine housing, weight may be saved. On the other hand, the cooling device enables the turbine housing to also withstand persistent loads of high temperatures. These measures contribute to a higher reliability and a longer lifecycle of the turbocharger.

In embodiments, which are combinable with all previously described embodiments, the insulation device may comprise a material which has a low thermal conductivity. In particular, the thermal conductivity may be less than 25 W/(m * K), preferably less than 5 W/(m * K), extremely preferably between 2 and 3 W/(m * K). In applications, the thermal conductivity of the material of the insulation device may lie between 0.01 and 3 W/(m * K), in particular between 0.02 and 1 W/(m * K). For example, the insulation device may comprise one or multiple materials selected in particular from ceramic, for example, steatite, specific insulating foams, and specific aerogels. The low thermal conductivity of the materials described has the advantage that minimal heat is transferred from the disk of the VTG cartridge to the turbine housing via the insulation device.

In embodiments, which are combinable with all previously described embodiments, the insulation device may be clamped between the disk and the turbine housing. Alternatively, the insulation device may be fixed to the disk and/or to the turbine housing. For example, the insulation device may be fixed, screwed, or welded on the disk or on the turbine housing. It may also be conceived that the insulation device comprises an insulation layer which may be applied directly on the disk and/or on the turbine housing. The insulation layer may, for example, comprise a specific aerogel and/or a specific insulating foam, which may have the requirements for thermal conductivity described above. The embodiments listed all have the advantage that they enable a simple assembly of the insulation device.

In embodiments, which are combinable with all previously described embodiments, the cartridge may have a heat-resistant material, in particular, it may be made of heat-resistant steel.

In an alternative configuration for a turbocharger with a turbine housing comprising the previously described cooling device with associated cooling ducts, it may be provided that the insulation device likewise has cooling ducts which are in fluidic connection with the cooling ducts of the turbine housing. It particular, it may also be additionally provided, or as a complete alternative to the insulation device, that the disk itself of the VTG cartridge has cooling ducts which are in fluidic connection with the cooling ducts of the turbine housing.

### BRIEF DESCRIPTION OF THE DRAWINGS

FIG. 1 shows a section through a turbocharger according to the invention according to a first embodiment;

FIG. 2 shows a section through a turbocharger according to the invention according to a second embodiment.

### DETAILED DESCRIPTION OF THE INVENTION

Embodiments of the turbocharger according to the invention will subsequently be described based on the figures.

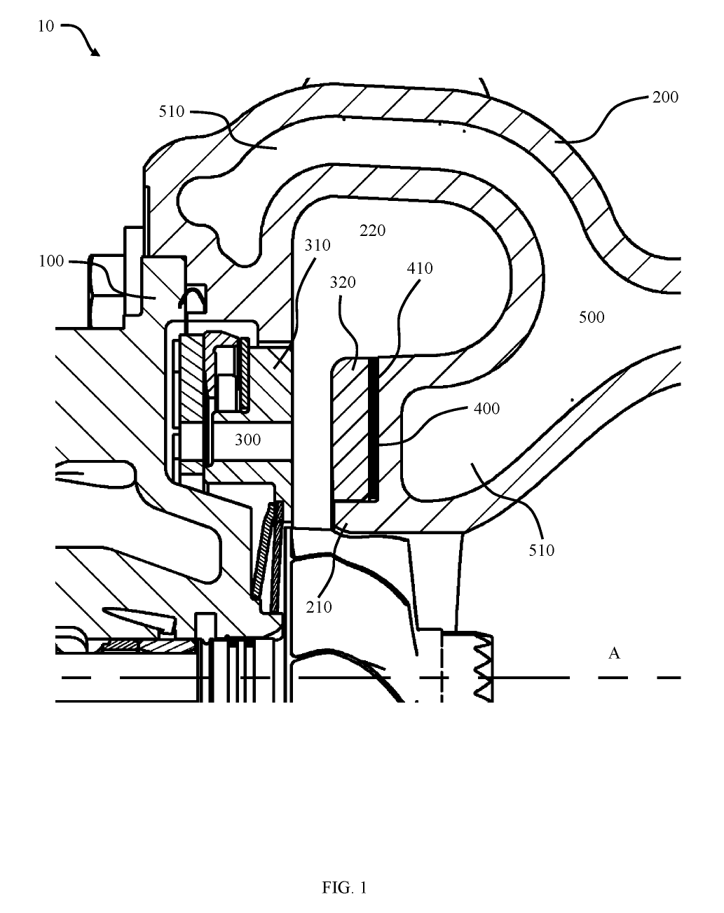

FIG. 1 shows a section through a part of a turbocharger 10 with variable turbine geometry (VTG). Turbocharger 10 as shown has a bearing housing 100 and a turbine housing 200 which is connected to bearing housing 100, for example, via a screw connection. In addition, a cartridge 300 with variable turbine geometry is assigned to turbocharger 10. VTG cartridge 300 comprises a blade bearing ring 310 and a disk 320, wherein a plurality of blades (not shown in the figures) is arranged between blade bearing ring 310 and disk 320. The VTG cartridge additionally comprises the corresponding mechanics to alter the blade position and thus for adjusting the turbine geometry. As is apparent in FIG. 1, an insulation device 400 is arranged between disk 320 and turbine housing 200. FIG. 1 shows an embodiment of insulation device 400 which is arranged between a first radial surface of disk 320, facing in the direction of turbine housing 200, and a second radial surface of turbine housing 200. This means that the insulation device is arranged between two surfaces that lie perpendicular to the axis A of turbocharger 10.

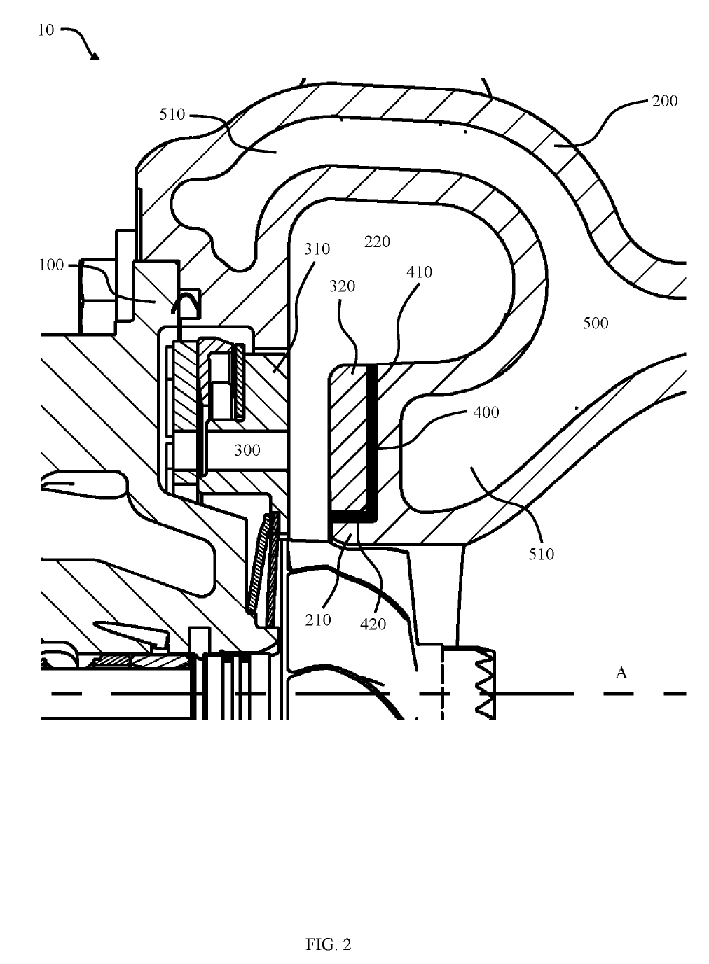

FIG. 2 shows an embodiment of the invention in which insulation device 400 is additionally arranged between an outer circumferential surface of a continuation 210 of turbine housing 200, which extends in the direction of bearing housing 100, and an inner circumferential surface of disk 320, which defines a mid-point in disk 320 (axis A runs through the mid-point of the hole and the center of disk 320). The turbine wheel of turbocharger 10 is likewise arranged in the area of the hole. Alternatively, it may be conceived that insulation device 400 is arranged between an inner circumferential surface of a continuation of turbine housing 200, which extends in the direction of bearing housing 100, and an outer circumferential surface of disk 320 (not shown in the figures). In this case, the continuation would be designed on the turbine housing on the diametrically opposite side of disk 320, in comparison to continuation 210, which is shown in FIG. 1 and FIG. 2.

During operation of turbocharger 10, hot exhaust gases are guided by turbine housing 200 between blade bearing ring 310 and disk 320 of cartridge 300 of the variable turbine geometry. Temperatures over 950° C. may thereby occur. An insulating device 400 between disk 320 of VTG cartridge 300 and turbine housing 200 has the advantage that the high temperatures, which disk 320 may reach during operation, are not directly transferred to turbine housing 200. This is particularly advantageous in case turbine housing 200 is manufactured from materials which have weight advantages, like aluminum, however are not suited for persistent high temperatures. This means that the material of turbine housing 200 is subjected to lower stress due to insulation device 400. Due to the lower stress and temperature loading, a higher durability and thus a higher lifecycle may be achieved for turbocharger 10.

Insulation device 400, as shown in FIG. 1, has a disk-shaped component 410. Disk-shaped component 410 is thereby designed as planar. The insulation device from the configuration in FIG. 2 additionally has a sleeve-like component 420. Disk-shaped component 410 and sleeve-like component 420 may be configured as an integral component. As is apparent in FIG. 2, sleeve-like component 420 extends from disk-shaped component 410 in the direction of bearing housing 100. In the case of an integral design, insulation device 400 in the configuration shown in FIG. 2 thus has a rotationally symmetrical component which has an L-shaped cross section. One part of the L-shaped cross section thereby runs in the axial direction (parallel to axis A) and the other part runs in the radial direction (perpendicular to axis A). This type of embodiment of insulation device 400 has the advantage that a direct contact or adjoining surfaces may be prevented between the disk of VTG cartridge 300 and turbine housing 200. Thus, a good heat insulation and a low heat transfer are enabled from disk 320 to turbine housing 200.

As is apparent in FIG. 1 and FIG. 2, disk 320 opens in the radially outward direction into an interior space 220 of turbine housing 200. This means that disk 320 is not directly surrounded by turbine housing 200 in this area, but instead by a volume of the volute which defines turbine housing 200. This has the advantage that the contact areas or adjoining surfaces or directly surrounding surfaces are kept to a minimum between disk 320 of VTG cartridge 300 and turbine housing 200. In other words, disk 320 opens radially outward into interior space 220 of turbine housing 200, which is part of the volute, and does not adjoin the turbine housing in this area. Thus, no heat transfer between disk 320 and turbine housing 200 occurs in the exterior circumferential area of disk 320. In the alternate embodiment described above (not shown in the figures), in which projection 210 is arranged on the diametrically opposite side of disk 320, disk 320 opens radially inward in the area of the turbine wheel into a volume of turbine housing 200. This means that, in these two preferred embodiments, the disk is always only surrounded in the radial direction on one side by the turbine housing, either on the interior or exterior.

The turbocharger shown in FIG. 1 and FIG. 2 has a turbine housing 200 which has a cooling device 500. Cooling device 500 has cooling ducts 510 which are arranged in turbine housing 200. In particular, ducts 510 are designed such that a coolant may circulate therein. The coolant may, for example, comprise water. A cooling device of this type is particularly advantageous if turbine housing 200 is manufactured from aluminum or another material which is not resistant to high temperatures.

In embodiments, which were previously described, insulation device 400 was to comprise a material which has a low thermal conductivity. In particular, the material used for insulation device 400 has a thermal conductivity which is less than 25 W/(m * K), preferably less than 5 W/(m * K), extremely preferably between 2 and 3 W/(m * K). In particular applications, the thermal conductivity of the material of insulation device 400 may lie between 0.01 and 3 W/(m * K), in particular between 0.02 and 1 W/(m * K). For example, insulation device 400 may comprise one or multiple materials selected in particular from ceramic, for example, steatite, specific insulating foams, and specific aerogels. The materials listed here merely provide a small selection of examples. In general, any material may be used for insulation device 400 which has the corresponding characteristics with respect to thermal conductivity and mechanical strength. The low thermal conductivity of the materials described has the advantage that minimum heat is transferred from disk 320 of VTG cartridge 300 to turbine housing 200 via insulation device 400. The thickness of insulation device 400, with respect to the thickness apparent in the section of FIG. 1 and FIG. 2, of radial and/or axial components 410 and 420, may lie in the range from 0.1 mm to 10 mm, particularly 0.5 mm to 5 mm, preferably between 1 mm and 2 mm.

Insulation device 400 is arranged between disk 320 of VTG cartridge 300 and turbine housing 200. According to the embodiment, insulation device 400 may be clamped between disk 320 and turbine housing 200. Alternatively, insulation device 400 may be fixed on disk 320 and/or on turbine housing 200. For example, insulation device 400 may be fixed, screwed, or welded on disk 320 or on turbine housing 200. In other embodiments, insulation device 400 may comprise an insulation layer which is applied directly to disk 320 and/or to the corresponding surface of turbine housing 200. The insulation layer may, for example, comprise a specific aerogel and/or a specific insulating foam, which may have the requirements for thermal conductivity described above. The embodiments listed in this section for the arrangement of insulation device 400 between disk 320 and turbine housing 200 all have the advantage that they enable a simple incorporation of insulation device 400 within the context of the assembly of turbocharger 10.

Cartridge 300, in particular the components of cartridge 300 comprising outer surfaces which face in the direction of the turbine interior volume (thus, for example, disk 320 and blade bearing ring 310), are to consist of a thermally-resistant material, in particular, for example, thermally-resistant steel.

In an alternative embodiment for a turbocharger with a turbine housing comprising the previously described the cooling device with associated cooling ducts, it may be provided that the insulation device likewise has cooling ducts which are in fluidic connection with the cooling ducts of the turbine housing (not shown in FIG. 1 and FIG. 2). It particular, it may also be additionally provided, or as a complete alternative to the insulation device, that the disk itself of the VTG cartridge has cooling ducts which are in fluidic connection with the cooling ducts of the turbine housing.

1. A turbocharger with variable turbine geometry comprising
a bearing housing;
a turbine housing which is connected to the bearing housing; and
a cartridge which comprises a blade bearing ring and a disk, wherein a plurality of blades is arranged between the blade bearing ring and the disk;
characterized in that, an insulation device is arranged between the disk and the turbine housing.

2. The turbocharger according to claim 1, wherein the insulation device is arranged between a first radial surface of the disk, facing in the direction of the turbine housing, and a second radial surface of the turbine housing.

3. The turbocharger according to claim 1, wherein the insulation device is arranged between an outer circumferential surface of a continuation of the turbine housing which extends in the direction of bearing housing, and an inner circumferential surface of disk, which defines a central hole in the disk.

4. The turbocharger according to claim 1, wherein the insulation device has a disk-shaped component.

5. The turbocharger according to claim 4, wherein the disk-shaped component is designed as planar.

6. The turbocharger according to claim 1, wherein the insulation device has a sleeve-like component.

7. The turbocharger according to claim 6 wherein the disk-shaped component and the sleeve-like component are configured as an integral component, wherein the sleeve-like component extends from the disk-shaped component in the direction of the bearing housing.

8. The turbocharger according to claim 1, wherein the insulation device has a rotationally-symmetrical component which has an L-shaped cross section.

9. The turbocharger according to claim 1, wherein the disk opens in the radially outward direction or in the radially inward direction into an interior space of the turbine housing and is not directly surrounded by the turbine housing in this area.

10. The turbocharger according to claim 1, wherein the turbine housing has a cooling device.

11. The turbocharger according to claim 10, wherein the cooling device has cooling ducts which are arranged in the turbine housing, in particular wherein the ducts are designed so that a coolant may circulate therein, wherein the coolant preferably comprises water.

12. The turbocharger according to claim 1, wherein the turbine housing comprises aluminum.

13. The turbocharger according to claim 1, wherein the insulation device comprises a material, which has a low thermal conductivity, in particular wherein the thermal conductivity is less than 25 W/(m * K), preferably less than 5 W/(m * K), extremely preferably between 2 and 3 W/(m * K).

14. The turbocharger according to claim 1, wherein the insulation device comprises one or multiple materials selected in particular from ceramic, for example, steatite, insulating foam, and aerogel.

15. The turbocharger according to claim 1, wherein the insulation device is clamped between the disk and the turbine housing.

16. The turbocharger according to claim 1, wherein the insulation device is fixed on the disk and/or on the turbine housing.

17. The turbocharger according to claim 1, wherein the insulation device comprises an insulation layer which is directly fixed on the disk and/or on the turbine housing.

18. The turbocharger according to claim 17, wherein the insulation layer is an aerogel and/or an insulating foam.

19. The turbocharger according to claim 1, wherein the cartridge has a heat-resistant material, in particular, heat-resistant steel.
